(19) United States
(12) Patent Application Publication
(10) Pub. No.: US 2019/0016024 A1
(43) Pub. Date: Jan. 17, 2019

(54) CALENDER, PRODUCTION LINE FOR FOAMED FLOOR, AND ONCE-FORMING PROCESS FOR PRODUCING FOAMED FLOOR

(71) Applicant: QINGDAO SANYI PLASTIC MACHINERY CO., LTD., Qingdao (CN)

(72) Inventor: YULIANG ZHOU, Qingdao (CN)

(21) Appl. No.: 15/855,533

(22) Filed: Dec. 27, 2017

Related U.S. Application Data
(63) Continuation-in-part of application No. PCT/CN2017/097794, filed on Aug. 17, 2017.

(30) Foreign Application Priority Data
Jul. 17, 2017 (CN) 201710580999.5
Jul. 17, 2017 (CN) 201720863810.9
Jul. 17, 2017 (CN) 201720865548.1
Jul. 17, 2017 (CN) 201720867916.6

(51) Int. Cl. B29C 43/24; B29C 43/52; B29C 59/04; E04F 15/10

(52) U.S. Cl. CPC B29C 43/24; B29C 43/52; B29L 2031/732; E04F 15/107; B29C 59/04

(57) ABSTRACT

A calender, comprising a base and a set of calendering rollers arranged on the base, wherein, the set of calendering rollers comprises a set of primary calendering rollers and a set of embossing rollers used for embossing a material to be processed; the set of primary calendering rollers and the set of embossing rollers are spaced apart for a distance to allow the material to be cooled before entering the set of embossing rollers from the set of primary calendering rollers. The calender can realize a better embossing effect, and integration production can be realized due to the use of the calender in a production of a foamed floor.

### CROSS-REFERENCE TO RELATED APPLICATIONS

This application is a continuation-in-part of International Application No. PCT/CN2017/097794, filed on Aug. 17, 2017, which in turn claims the priority benefits of Chinese application No. 201710580999.5, filed on Jul. 17, 2017, Chinese application No. 201720865548.1, filed on Jul. 17, 2017, Chinese application No. 201720867916.6, filed on Jul. 17, 2017, and Chinese application No. 201720863810.9, filed on Jul. 17, 2017. The disclosure of which are hereby incorporated by reference in their entirety.

### TECHNICAL FIELD

The present application relates to a field of mechanical manufacturing, and in particular to a calender, a production line for a foamed floor, and a once-forming process for producing a foamed floor.

### BACKGROUND OF THE PRESENT INVENTION

Compared with a conventional wooden floor, a foamed floor has following advantages: (1) the foamed floor is soft, good at waterproofness and moisture resistance, highly elastic with good elastic recovery under impact of heavy objects, and not easy to be damaged; (2) the foamed floor is environmentally friendly, and is a recyclable product; (3) the foamed floor has good flame retardancy and high safety coefficient; and, (4) the foamed floor is low in cost and less expensive than wooden floors; and the like. Based on the above advantages, the foamed floor has a wider development prospect and application space.

The foamed floor mainly comprise SPC (Stone-Plastic Composite) foamed floor and WPC (Wood-Plastic Composite) foamed floor, and structure of the SPC foamed floor and WPC foamed floor mainly comprise an intermediate foamed layer and solid layers on two sides of the foamed layer. A main difference between the two kinds of foamed floor is that ratios of PVC (Polyvinyl chloride) powder to calcium powder of the foamed layer and the solid layers in the WPC foamed floor are different from that in the SPC foamed floor.

On one hand, as price of the calcium powder is lower than that of the PVC powder, the SPC foamed floor usually adopts more parts of calcium powder so as to reduce cost; on the other hand, due to higher density of the calcium powder, weight of the SPC foamed floor will be increased. Specific description is as follows:

According to design requirements, the foamed layer and solid layers in the SPC foamed floor adopt more calcium powder, for example, in parts by weight, the ratio of PVC powder to calcium powder is 1:2 or 1:3, as the price of the calcium powder is low and the density of the calcium powder is high, the weight of the SPC foamed floor is heavy, and the price and the cost of the SPC foamed floor are low.

However, for the WPC foamed floor, the parts of calcium powder are reduced, the ratio of the PVC powder to the calcium powder in solid layers can still be 1:2 or 1:3 (or other ratio), and an amount of calcium powder added in the foamed layer is reduced, for example, the ratio of the PVC powder to the calcium powder in the foamed layer is 1:1, reducing the amount of calcium powder can reduce the weight of the floor as a whole, and although the cost of the floor may be increased, it can meet people's growing requirements on quality.

The change of the ratios of raw materials in the WPC foamed floor can directly cause a change of foaming performance of the raw materials, and new requirements on equipment and process for producing the WPC foamed floor are proposed.

In the prior art, a process for producing the WPC foamed floor is as follows: substrate extruding-surface sanding-gluing-pasting-stacking-cold pressing-regimen (preserving for a period of time in a constant-temperature workshop)-cutting-slotting-detecting and packaging-palletizing-putting in storage and packing. On one hand, since the layers, such as the foamed layer, the solid layers, a color film layer, a wear-resistant layer and the like, are pasted together by glue, it is low in efficiency and is not environmentally friendly; on the other hand, various steps are performed by stages, and operations in each step need to be performed by a specially-assigned person operating a special machine, so that it is troublesome and labor-consuming.

To realize streamlined operations, there are production lines for SPC foamed floors in the prior art. For example, Chinese Patent CN105459422A has disclosed a molding mechanism for once-processing a SPC floor, including a mixer, an extruder, a feeder, a mold, a calender and the like. Various powdery materials are mixed, extruded and processed by the mold to obtain a blank; and the blank is directly fed into a roll shaft assembly of the calender for completing various processes such as calendering, film pasting and embossing.

Moreover, Chinese Patent CN205553494U has disclosed a four-roller calendering and lamination production device for SPC floor surface, and provided a calender for producing a stone-plastic floor. The calender comprises an upper mirror-surface roller, a lower mirror-surface roller, a bottom grain roller and an embossing roller. A material blank directly enters the bottom grain roller and the embossing roller after passing through the mirror-surface rollers. On one hand, the method is difficult to guarantee an embossing effect, and on the other hand, the production device for SPC floor cannot be directly used in a production of the WPC foamed floor. Therefore, a set of an improved device and an improved process are needed.

The production devices and processes disclosed by the above patents are not suitable for once-forming production of a WPC foamed floor. Adopting the traditional processes may cause following problems: due to the ratio of PVC powder to calcium powder has changed, a performance of the material is changed, and thus calendering process and effects of embossing and knurling may be influenced and some problems are occurred, such as failed embossing or pattern rebounded after embossing. There is no process that can realize once-forming production of the WPC foamed floor in the prior art.

### SUMMARY OF THE PRESENT INVENTION

An object of the present application is to provide a calender for producing a WPC foamed floor, and in view of problems in process for producing a foamed floor in the prior art, especially problems in process for producing the WPC foamed floor, further provides a production line for a foamed floor and a once-forming process for producing a foamed floor.

For the above objects, the present application provides the following solutions.

A calender, comprising a base and a set of calendering rollers arranged on the base, the set of calendering rollers comprises a set of primary calendering rollers and a set of embossing rollers used for embossing a material to be processed; the set of primary calendering rollers and the set of embossing rollers are spaced apart for a distance to allow the material to be cooled before entering the set of embossing rollers from the set of primary calendering rollers.

The set of primary calendering rollers is a set of rollers consisting of calendering rollers, comprising mirror-surface rollers. The calendering rollers in the set of primary calendering rollers may be all mirror-surface rollers, or other types of calendering rollers may also be selected according to requirements. A configuration of the set of embossing rollers is determined according to embossing requirements. For example, some materials are to be embossed on both sides, while some materials are to be embossed on a single side. Due to different requirements, the configuration is different. According to processing requirements, the set of primary calendering rollers is responsible for one or more of flattening, film attaching, delustering, sanding and other procedures. In order to ensure that embossing effect is not damaged, the embossing process usually follows the above procedures. Therefore, according to a processing flow of the material, the set of calendering rollers successively comprises the set of primary calendering rollers and the set of embossing rollers used for embossing the material to be processed. The set of primary calendering rollers and the set of embossing rollers are configured to be spaced apart. Specifically, a discharge end of the set of primary calendering rollers and a feed end of the set of embossing rollers are spaced apart for such a distance that allows the material to be cooled before entering the set of embossing rollers from the set of primary calendering rollers. For example, according to a common processing flow, the material can be cooled before entering the feed end of the set of embossing rollers from the discharge end of the set of primary calendering rollers. The distance is not a fixed distance. Instead, it is determined by the processing requirements. For example, the distance may be 0.5m, 0.8m, 1m or the like.

Preferably, a set of cooling rollers is provided between the set of primary calendering rollers and the set of embossing rollers. For example, the set of cooling rollers is provided between a final discharge end of the set of primary calendering rollers and the feed end of the set of embossing rollers. With regard to a structure without the set of cooling rollers, the material is cooled naturally. However, by additionally designing the set of cooling rollers, the material may be cooled quickly, and thus the distance between the set of primary calendering rollers and the set of embossing rollers may be correspondingly decreased so that the calender becomes more compact in structure.

Preferably, according to the processing flow of the material, the calender successively comprises a cooling and shaping device, the set of primary calendering rollers and the set of embossing rollers. The cooling and shaping device is used for shaping the material by cooling.

Preferably, the cooling and shaping device comprises a first cooling component and a second cooling component spaced apart; a gap between the first cooling component and the second cooling component allows the material to be processed to pass therethrough and ensures that the material to be processed comes into contact with both the first cooling component and the second cooling component when passing through the gap, so as to realize cooling and shaping.

Preferably, the cooling and shaping device comprises a first cooling roller and a second cooling roller pairwise spaced apart, or a first cooling and shaping plate and a second cooling and shaping plate pairwise spaced apart, or a combination of a first cooling roller and a second cooling roller pairwise spaced apart and a first cooling and shaping plate and a second cooling and shaping plate pairwise spaced apart. Specifically, according to different cooling and shaping requirements of materials to be processed, the first cooling roller and the second cooling roller spaced apart may be selected as the cooling and shaping device, so that the material passes through a gap between the first cooling roller and the second cooling roller for cooling and shaping; or, the first cooling and shaping plate and the second cooling and shaping plate may be selected as the cooling and shaping device, so that the material passes through a gap between the two cooling and shaping plates for cooling and shaping; or, a combination of two sets of cooling devices, comprising the first cooling roller and the second cooling roller and the first cooling and shaping plate and the second cooling and shaping plate, may be selected as the cooling and shaping device, so that the material successively passes through the two sets of cooling devices.

Preferably, at least one of the first cooling roller and the second cooling roller is configured with a cooling pipeline for feeding a cooling liquid; and/or, at least one of the first cooling and shaping plate and the second cooling and shaping plate is configured with a cooling pipeline for feeding a cooling liquid.

Preferably, a cooling gap adjustment device(s) is/are connected to the first cooling roller and/or the second cooling roller, and/or, to the first cooling and shaping plate and/or the second cooling and shaping plate, i.e. at least one of the first cooling roller and the second cooling roller is configured with a cooling gap adjustment device, and/or, at least one of the first cooling and shaping plate and the second cooling and shaping plate is configured with a cooling gap adjustment device; and, the cooling gap adjustment device is used for adjusting the gap between the first cooling roller and the second cooling roller or between the two cooling and shaping plates to allow sheets of different sizes to pass therethrough.

Preferably, according to the processing flow of the material, the cooling and shaping device successively comprises a pair of cooling and shaping plates and a pair of cooling rollers, and the pair of cooling and shaping plates comprises the first cooling and shaping plate and the second cooling and shaping plate pairwise spaced apart, and, the pair of cooling rollers comprises the first cooling roller and the second cooling roller pairwise spaced apart. For a material to be processed into a planar shape, the pair of cooling and shaping plates can realize better shaping effect than the pair of cooling rollers. The material will be basically shaped after it is cooled and flattened by the cooling and shaping plates; and then the material will be further flattened by the the first cooling roller and the second cooling roller for realizing better flattening effect.

Preferably, the set of embossing rollers comprises a pattern roller or an anilox roller or a combination of a pattern roller and an anilox roller, and the pattern roller and the anilox roller are configured to come into contact with different surfaces to be embossed of the material to be processed, respectively. Taking processing a foamed floor as an example, the pattern roller is arranged on a side contacting with a top surface of the foamed floor, and the anilox roller is arranged on a side contacting with a bottom surface of the foamed floor. According to the embossing requirements, a structure of the set of embossing rollers may also be improved. For example, only the pattern roller or the anilox roller is provided when the material is to be embossed on a single side.

Preferably, the calender further comprises a film winding and unwinding mechanism and a guide and attaching mechanism used for guiding a film unwinded by the film winding and unwinding mechanism to the set of primary calendering rollers; and, the guide and attaching mechanism comprises a guide wheel and an attaching roller spaced apart from the calendering rollers in the set of primary calendering rollers. The guide wheel may be a single guide wheel or a set of guide wheels, which functions to cooperate with the attaching roller to guide the film unwinded by the film winding and unwinding mechanism to a desired position. The attaching roller is arranged at a position close to the calendering rollers in the set of primary calendering rollers, so that the material is attached with a desired film before passing through a gap between the calendering rollers in the set of primary calendering rollers. The set of primary calendering rollers may comprise a plurality of calendering rollers. To which calendering roller the film is guided is specifically determined according to the processing requirements.

Preferably, the film winding and unwinding mechanism comprises any one of or any combination of a substrate film winding and unwinding mechanism for unwinding a substrate film, a color film winding and unwinding mechanism for unwinding a color film, and a wear-resistant film winding and unwinding mechanism for unwinding a wear-resistant film; and, if the substrate film winding and unwinding mechanism is configured to guide the substrate film to one side of the material, both the color film winding and unwinding mechanism and the wear-resistant film winding and unwinding mechanism are configured to guide the color film and the wear-resistant film to an other side of the material. According to different processing requirements, types of required films will be different. Taking processing a foamed floor as an example, it is possible to attach one of or a combination of two or three of the substrate film, the color film and the wear-resistant film, and a corresponding film winding and unwinding mechanism is configured according to requirement. Since the substrate film and other two films (the color film and the wear-resistant film) are generally fitted onto different surfaces of the foamed floor, that is, the substrate film is attached onto a surface close to a ground while the color film and the wear-resistant film are attached onto a surface away from the ground, thus the films are guided to different positions.

Preferably, the calender further comprises an auxiliary attaching roller which is located at a rear end of the attaching roller, arranged at a same calendering roller as the attaching roller, and spaced apart from the calendering roller. A film is attached by the attaching roller first, and further auxiliarily attached by the auxiliary attaching roller to ensure that the film is attached more firmly.

Preferably, each of the attaching roller and the auxiliary attaching roller is connected to a gap adjustment device for adjusting a gap between the attaching roller or the auxiliary attaching roller and the calendering roller in the set of primary calendering rollers, respectively. Such a structure can adapt to different thicknesses of materials and processing requirements of materials of different thicknesses, and the gap between the attaching roller and the calendering roller and the gap between the auxiliary roller and the calendering roller may be adjusted to ensure an attaching quality and processing requirements on the material thickness.

A production line for a foamed floor is provided, comprising the calender.

A once-forming process for producing a foamed floor is provided, which is realized based on the production line for the foamed floor, comprising following steps: discharging a material by the set of primary calendering rollers, and then cooling the material during conveying, and whereafter, feeding the material into the set of embossing rollers for embossing. A temperature of cooled material is determined according to characteristic of the material and an embossing requirement, and is not a fixed value.

Preferably, the once-forming process for producing a foamed floor further comprises following steps: cooling and shaping the material by the cooling and shaping device firstly, and then feeding the material to the set of primary calendering rollers. A purpose of the cooling and shaping is to prevent the material from bending in a wavy shape and thus to ensure a final processing quality.

Preferably, according to the processing flow, the set of primary calendering rollers successively comprises a first mirror-surface roller, an intermediate mirror-surface roller and a discharge end calendering roller and a temperature of the discharge end calendering roller is higher than a temperature of the first mirror-surface roller. According to the processing flow, the first mirror-surface roller is a calendering roller close to a discharge end of the cooling and shaping device, the discharge end calendering roller is a calendering roller close to the set of embossing rollers, and the intermediate mirror-surface roller is a transitional calendering roller through which the material travels from the first mirror-surface roller to the discharge end calendering roller.

Preferably, according to the processing flow, the set of primary calendering rollers successively comprises the first mirror-surface roller, a set of intermediate mirror-surface rollers consisting of at least two intermediate mirror-surface rollers, and the discharge end calendering roller, wherein temperatures of both the first mirror-surface roller and an intermediate mirror-surface roller adjacent to the first mirror-surface roller are set at 30° C. to 90° C., the temperature of the discharge end calendering roller is set at 150° C. to 190° C., a temperature of an intermediate mirror-surface roller adjacent to the discharge end calendering roller is set at 90° C. to 170° C.

Preferably, a temperature of a pattern roller is set at 160° C. to 190° C., and a temperature of an anilox roller is set at 160° C. to 190° C.

Preferably, the production line further comprises a mixer and a feeder; and, the material is fed into the mixer, then mixed with a cold material during a heating and stirring process, and fed into the feeder after being cooled.

The present application has the following beneficial effects.

(1) Since the set of primary calendering rollers and the set of embossing rollers of the calender are arranged separately, the material may be cooled naturally when moving between the set of primary calendering rollers and the set of embossing rollers. Cooling rollers may also be designed for auxiliary cooling. During a cooling process, a performance of the material will be changed, so that it is advantageous to ensure a quality of subsequent processing. For example, during a processing process for a foamed floor, a material is discharged from the set of primary calendering rollers and then enters the set of embossing rollers after traveling a certain distance. During its traveling, a temperature of the foamed floor will be decreased, and a better embossing effect may be thus realized.

(2) The present application provides a once-forming process for producing a WPC foamed floor, and corresponding changes are made to controls of foaming process and films attaching process. The process specifically comprises: once-forming-regimen-cutting-slotting-detecting and packaging-palletizing-putting in storage and packing. Compared with conventional production processes, the process omitting steps such as gluing, pasting and the like, so that devices are saved, and occupation space may also be saved. Since no gluing process is needed, materials can be saved and environmental performance can be improved. Since no sanding process is needed, dust pollution can be reduced. Moreover, due to streamlined operations in the production line, a labor cost can be saved.

(3) In the present application, a set of temperature control strategies for the process for producing the WPC foamed floor has been studied. By setting temperatures of the set of primary calendering rollers and the set of embossing rollers and in combination with a structural design with cooling functions in the cooling and shaping device and between the set of primary calendering rollers and the set of embossing rollers, the material is modified during travelling from high temperature to low temperature, so that the foaming effect and embossing effect of finished products may be greatly improved and a rejection rate may be decreased.

### BRIEF DESCRIPTION OF THE DRAWINGS

FIG. 1 is a structural schematic diagram of a calender in Embodiment 1;

FIG. 2 is a structural schematic diagram of a set of primary calendering rollers and a set of embossing rollers;

FIG. 3 is a structural schematic diagram of a cooling and shaping device;

FIG. 4 is a structural schematic diagram of a calender in Embodiment 2;

FIG. 5 is a structural schematic diagram of a calender in Embodiment 3;

FIG. 6 is a structural schematic diagram of a substrate film winding and unwinding mechanism and a substrate film guide and attaching mechanism in Embodiment 3;

FIG. 7 is a structural schematic diagram of a wear-resistant film winding and unwinding mechanism and a wear-resistant film guide and attaching mechanism in Embodiment 3;

FIG. 8 is a structural schematic diagram of a color film winding and unwinding mechanism and a color film guide and attaching mechanism in Embodiment 3;

FIG. 9 is a structural schematic diagram of an auxiliary attaching roller in Embodiment 3;

FIG. 10 is a structural schematic diagram of a production line for a foamed floor; and

FIG. 11 is a structural schematic diagram of the production line from a top view; in which:

1: calender;
11: base;
12: a set of primary calendering rollers;
1201: first mirror-surface roller;
1202: first intermediate mirror-surface roller;
1203: second intermediate mirror-surface roller;
1204: delustering roller;
13: a set of embossing rollers;
1301: pattern roller;
1302: anilox roller;
14: cooling roller;
15: cooling and shaping device;
1501: first cooling roller;
1502: second cooling roller;
1503: first cooling gap adjustment cylinder;
1504: first cooling and shaping plate;
1505: second cooling and shaping plate;
1506: second cooling gap adjustment cylinder;
161: substrate film winding and unwinding mechanism;
162: substrate film guide and attaching mechanism;
1621: substrate film guide wheel;
1622: substrate film attaching roller;
1623: first gap adjustment cylinder;
171: wear-resistant film winding and unwinding mechanism;
172: wear-resistant film guide and attaching mechanism;
1721: wear-resistant film guide wheel;
1722: wear-resistant film attaching roller;
1723: second gap adjustment cylinder;
181: color film winding and unwinding mechanism;
182: color film guide and attaching mechanism;
1821: color film guide wheel;
1822: color film attaching roller;
1823: third gap adjustment cylinder;
19: auxiliary attaching roller;
1903: fourth gap adjustment cylinder;
2: mixer;
201: first mixer;
202: second mixer;
3: feeder;
301: first feeder;
302: second feeder;
4: extruder;
401: first extruder;
402: second extruder
5: mold;
6: cooling bracket;
7: tractor;
8: arched bracket;
9: precise sheet cutting machine;
20: conveying bracket; and
21: automatic sheet lifting machine.

### DETAILED DESCRIPTION OF THE PRESENT INVENTION

The specific implementations of the present application will be clearly and completely described below with reference to the drawings. Apparently, embodiments described in the specific implementations are a part of but not all of the embodiments of the present application. All other embodiments obtained based on the embodiments in the present application by a person skilled in the art without paying any creative effort shall fall into the protection scope of the present application.

It is to be noted that, a “bottom side” in the embodiments refers to a side of a foamed floor contacting with a ground after the foamed floor is mounted, and a “top side” refers to a side of the foamed floor contacting with a user after the foamed floor is mounted; and they should not be interpreted as limitations to the present application. In addition, terms “first”, “second” and “third” are merely used for descriptive purpose, and cannot be interpreted explicitly or implicitly as relative importance. A “travelling direction”, a “material incoming direction”, and a “processing flow” in the present application are used for assisting in indicating a processing flow of a material; a “front” and a “front end” are used for indicating a procedure to be completed first in the processing flow; and, a “rear” and a “rear end” are used for indicating a procedure to be completed subsequently in the processing flow.

### Embodiment 1

This embodiment provides a calender 1 for once-forming production of a WPC foamed floor. The calender 1 can realize a once-forming of several procedures such as foaming, embossing or knurling respectively on a bottom side and a top side of a material to be processed and so on. The embossing process means calendering a reticular pattern on a bottom of the material; and the knurling process means calendering a decorative pattern on a top surface of the material. Hereinafter, the “embossing” represents both the embossing process and the knurling process for short. In this embodiment, the material to be processed is a blank of the WPC foamed floor (hereinafter referred to as blank for short). However, in practical applications, the material to be processed is not limited to the blank of the WPC foamed floor.

The calender 1 comprises a base 11 and sets of calendering rollers arranged on the base 11. According to a material processing flow (in this embodiment, the material is the blank of the WPC foamed floor), the sets of calendering rollers successively comprise a set of primary calendering rollers 12 and a set of embossing rollers 13 used for embossing both sides of the blank.

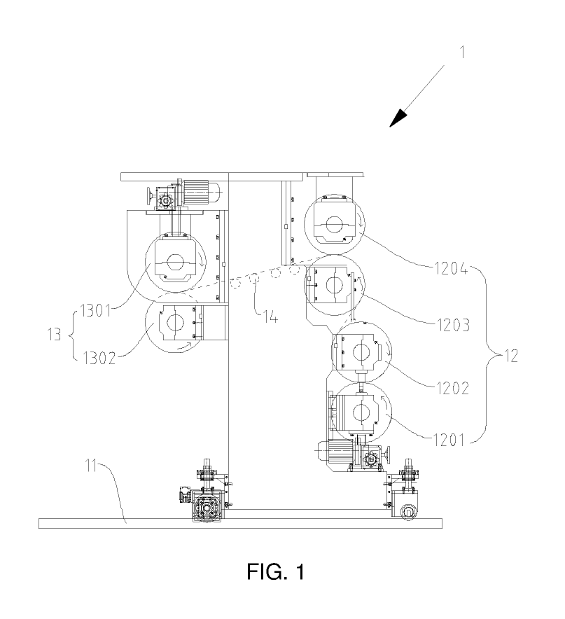

FIG. 1 shows a schematic diagram of an implementation of the calender.

The set of primary calendering rollers 12 is a set of rollers consisting of calendering rollers, comprising mirror-surface rollers. The calendering rollers in the set of primary calendering rollers 12 may be all mirror-surface rollers, or other types of calendering rollers may also be selected according to requirements. According to the processing flow (that is a travelling order of the blank between calendering rollers in the set of primary calendering rollers), the set of primary calendering rollers 12 successively comprises a first mirror-surface roller 1201, a set of intermediate mirror-surface rollers consisting of intermediate mirror-surface rollers, and a discharge end calendering roller, which are spaced apart with gaps reserved therebetween. The blank passes through the gaps between adjacent calendering rollers. A feed end between the first mirror-surface roller 1201 contacting with the blank and an intermediate mirror-surface roller adjacent thereto is an initial feed end of the set of primary calendering rollers; feed ends between the intermediate mirror-surface rollers and a feed end between the intermediate mirror-surface roller and the discharge end calendering roller are inter-roller feed ends; and, the discharge end between the discharge end calendering roller and the intermediate mirror-surface roller adjacent thereto is a final discharge end of the set of primary calendering rollers. The discharge end calendering roller may be a calendering roller in various forms, depending upon processing requirements.

Taking a specific implementation structure of the calender as example, in this embodiment, the set of primary calendering rollers 12 comprises a first mirror-surface roller 1201, a first intermediate mirror-surface roller 1202, a second intermediate mirror-surface roller 1203 and a delustering roller 1204 (the delustering roller 1204 is a discharge end calendering roller, and may be replaced with a calendering roller of other types, such as a mirror-surface roller or a sanding roller), which are spaced apart. An end, facing the material incoming direction, between the first mirror-surface roller 1201 and the first intermediate mirror-surface roller 1202 is the initial feed end of the set of primary calendering rollers 12. The blank enters from the feed end, then passes through a gap between the first mirror-surface roller 1201 and the first intermediate mirror-surface roller 1202, and then passes through a gap between the first intermediate mirror-surface roller 1202 and the second intermediate mirror-surface roller 1203. The first mirror-surface roller 1201 and the first intermediate mirror-surface roller 1202 are connected to motion driving mechanisms and have opposite directions of rotation (the directions of rotation refer to directions indicated by arrows in the drawings); and, the second intermediate mirror-surface roller 1203 and the delustering roller 1204 are also connected to motion driving mechanisms and have opposite directions of rotation (the directions of rotation refer to directions indicated by arrows in the drawings). A discharge end between the second intermediate mirror-surface roller 1203 and the delustering roller 1204 is the final discharge end of the set of primary calendering rollers 12. The blank enters the set of embossing rollers 13 from the final discharge end of the set of primary calendering rollers 12 for executing an embossing process.

In practical applications, a number of the intermediate mirror-surface rollers and spaces between the mirror-surface rollers may be configured according to a material condition and requirements of mirror calendering. For example, three intermediate mirror-surface rollers may be used. Or, in a simpler structure, no intermediate mirror-surface roller may be configured, and only the first mirror-surface roller 1201 and the discharge end calendering roller are provided.

The set of embossing rollers 13 comprises a pattern roller 1301 and an anilox roller 1302, which are spaced apart. The pattern roller 1301 and the anilox roller 1302 are configured to come into contact with different surfaces to be embossed of the blank, respectively. Specifically, in this embodiment, the anilox roller 1302 is arranged on a side contacting with the bottom side of the blank, and the pattern roller 1301 is arranged on a side contacting with the top side of the blank. The blank is discharged from the final discharge end of the set of primary calendering rollers 12 and then enters a gap between the pattern roller 1301 and the anilox roller 1302. Subsequently, the pattern roller 1301 and the anilox roller 1302 emboss both sides of the surface of the blank, respectively.

It is to be noted that, in this embodiment, the structure of the calender is described by a demand for embossing both sides of the blank. In practical applications, if no decorative pattern needs to be embossed on the top side, the pattern roller 1301 may be omitted, and the pattern roller 1301 may be replaced by a mirror-surface roller configured at an end contacting with the top side of the blank; and, if no reticulate pattern needs to be embossed on the bottom side, the anilox roller 1302 may be omitted, and the anilox roller 1302 may be replaced by a mirror-surface roller configured at an end contacting with the bottom side of the blank.

Temperatures of the calendering rollers in both the set of primary calendering rollers 12 and the set of embossing rollers 13 are usually high. Therefore, if the blank directly enters the set of embossing rollers 13 from the final discharge end of the set of primary calendering rollers 12, due to good elasticity and thermal expansion of the blank at a high temperature, embossed patterns are mostly rebounded, and embossing effect is thus poor.

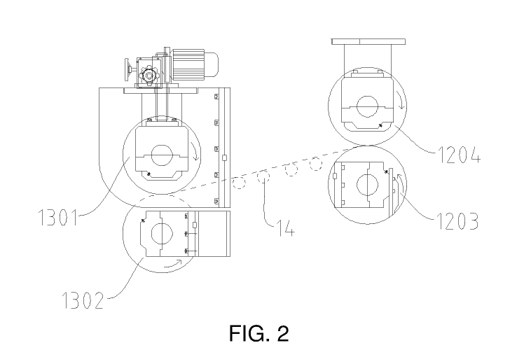

In order to solve this problem, the final discharge end of the set of primary calendering rollers 12 and a feed end of the set of embossing rollers 13 are spaced apart for such a distance that allows the blank to be cooled before entering the feed end of the set of embossing rollers 13 from the final discharge end of the set of primary calendering rollers 12. The detail refers to FIG. 2. The distance is set according to various parameters such as performance and thickness of the blank, and is not a fixed distance. For example, in this embodiment, taking processing the blank of the WPC foamed floor as example, the distance is 100 cm (it is to be noted that the distance should not be too large and after the blank leaves from the final discharge end of the set of primary calendering rollers 12 at a little distance, the embossing process should be performed, because the embossed pattern will be less textured if there is a too large distance between them or the blank is cooled excessively). Since the blank is cooled before entering the set of embossing rollers 13, the blank has a cold contraction performance. In this case, if the blank is embossed at a high temperature, the pattern quality will be high. Taking processing the blank of the WPC foamed floor as example, the foamed floor is cooled to about 110° C. to 130° C. after travelling a certain distance. The specific cooling temperature is determined according to a thickness of the wear-resistant film and a thickness of the foamed floor. A desired embossing effect is specifically determined according to the performance and requirements of the blank.

By configuring the set of primary calendering rollers 12 and the set of embossing rollers 13 to be spaced apart for a certain distance, the blank may be cooled by air. In order to realize better cooling effect and quicken cooling of the blank, a set of cooling rollers is provided between the final discharge end of the set of primary calendering rollers 12 and the feed end of the set of embossing rollers 13. The set of cooling rollers comprises a plurality of cooling rollers 14, and the cooling rollers 14 play a role in cooling and guiding. The blank is further cooled by the cooling rollers 14 when travelling above the cooling rollers 14, and then enters the feed end of the set of embossing rollers 13. By providing the cooling rollers 14, the distance between the final discharge end of the set of primary calendering rollers 12 and the feed end of the set of embossing rollers 13 may be decreased. For example, in this embodiment, the distance may be decreased to 80 cm. It is advantageous to decrease an overall size of the calender.

As an auxiliary design, in order to ensure that the blank can successfully travel from the set of primary calendering rollers 12 to the set of embossing rollers 13, the calender further comprises an embossing guide mechanism used for guiding the blank from the final discharge end of the set of primary calendering rollers 12 to the set of embossing rollers 13. For example, the embossing guide mechanism is a set of guide wheels consisting of a plurality of guide wheels.

### Embodiment 2

During a production, there is another question that will result in poor quality of products and influence the embossing quality. The calender usually processes flat materials. Usually, hot extrudate is fed into the calender for processing. However, often, the hot extrudate processed by an extruder and a mold can not guarantee good flatness, and usually bent in a wavy shape.

In order to ensure that the material has good flatness before entering the celender, in accordance with the processing flow of the material and based on Embodiment 1, the calender 1 further comprises a cooling and shaping device 15 which is arranged in front of the initial feed end of the set of primary calendering rollers 12 and used for cooling and shaping the material to be processed. The cooling and shaping device 15 comprises a first cooling component and a second cooling component spaced apart. A gap between the first cooling component and the second cooling component allows the material to be processed to pass therethrough and ensures that the material to be processed comes into contact with both the first cooling component and the second cooling component when passing through the gap.

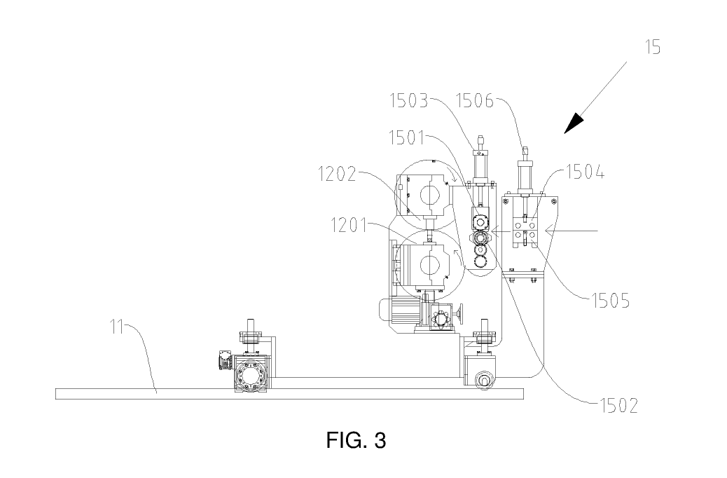

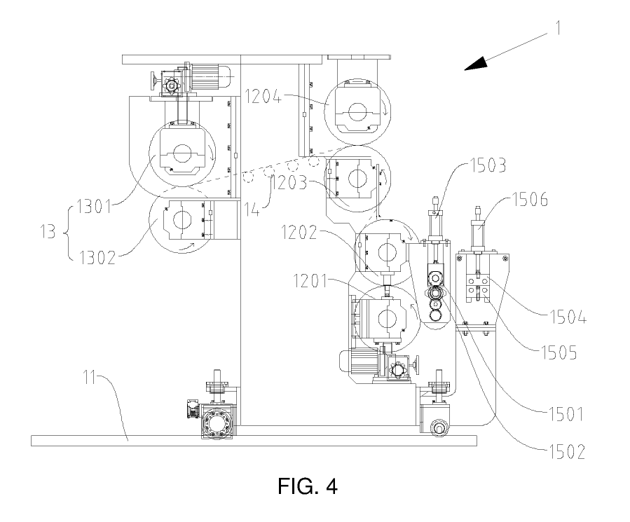

FIG. 3 shows a structure of the cooling and shaping device 15 in this embodiment, and FIG. 4 shows a calender configured with the cooling and shaping device 15.

The cooling and shaping device 15 is arranged in front of the feed end between the first mirror-surface roller 1201 and the first intermediate mirror-surface roller 1202 in the material incoming direction, and comprises a first cooling roller 1501 and a second cooling roller 1502 spaced apart. A cooling pipeline(s) for feeding a cooling liquid is/are provided inside the first cooling roller 1501 and/or the second cooling roller 1502. In other words, in order to enable the first cooling roller 1501 or the second cooling roller 1502 to play a cooling role, it is necessary to at least ensure that a cooling pipeline is provided inside one of the first cooling roller 1501 and the second cooling roller 1502. Meanwhile, in order to realize uniform cooling effect, the cooling pipeline may be provided inside each of the first cooling roller 1501 and the second cooling roller 1502. A cooling liquid is fed into the cooling pipeline, and a sheet is cooled by a heat exchange between the cooling liquid and the sheet. Here, the cooling pipeline includes a cooling liquid inlet and a cooling liquid outlet so that the cooling liquid may be replaced.

It is to be noted that, in addition to the first cooling roller 1501 and the second cooling roller 1502, the cooling components may employ structures in other forms, for example, cooling and shaping plates pairwise spaced apart and the like.

Further, due to different thicknesses and sizes of sheets, in order to enable sheets of various thicknesses and sizes to pass through the gap between cooling components, the first cooling roller 1501 and/or the second cooling roller 1502 are/is connected to a cooling gap adjustment device(s). In this embodiment, the first cooling roller 1501 is located above the second cooling roller 1502, and first cooling roller 1501 is connected to the cooling gap adjustment device which is a first cooling gap adjustment cylinder 1503. Due to expansion and contraction actions of the first cooling gap adjustment cylinder 1503, the gap between the first cooling roller 1501 and the second cooling roller 1502 is adjusted. It should be understood that, the cooling gap adjustment device can realize gap adjustment and is not limited to a specific structure, and the cylinder is one embodiment.

During the production, the sheet to be processed passes through the gap between the first cooling roller 1501 and the second cooling roller 1502 so as to be cooled and molded.

In order to realize better shaping effect, the cooling and shaping device 15 further comprises a first cooling and shaping plate 1504 and a second cooling and shaping plate 1505 pairwise spaced apart. A gap between the cooling and shaping plates allows a sheet to pass therethrough and ensures that the sheet comes into contact with the two cooling and shaping plates when passing through the gap. The cooling and shaping plates are flat, and may better flatten the sheet for shaping in comparison to the first cooling roller 1501 and the second cooling roller 1502. Similarly, at least one of the first cooling and shaping plate 1504 and the second cooling and shaping plate 1505 is configured with a cooling pipeline for feeding a cooling liquid inside and is connected to a cooling gap adjustment device. In this embodiment, the first cooling and shaping plate 1504 is located above the second cooling and shaping plate 1505, and a cooling gap adjustment device which is a second cooling gap adjustment cylinder 1506 is mounted on the first cooling and shaping plate 1504.

In the material incoming direction, the cooling and shaping plates 1504 and 1505 are located in front of the first cooling roller 1501 and the second cooling roller 1502. A direction indicated by an arrow in FIG. 3 is a travelling direction of the sheet during the production. In other words, during the processing, the sheet is passed through the gap between the cooling and shaping plates first for pressing, cooling and shaping, and then the sheet is passed through the gap between the first cooling roller 1501 and the second cooling roller 1502 to be further pressing, cooling and shaping; and finally, the sheet enters the set of primary calendering rollers 12. In order to ensure that the sheet successfully pass through the cooling and shaping device 15, the gap between the first cooling roller 1501 and the second cooling roller 1502 and the gap between the cooling and shaping plates are kept in a same horizontal plane.

According to requirements of cooling and shaping, a combination of the first cooling roller 1501 and the second cooling roller 1502 or a combination of the first cooling and shaping plate 1504 and the second cooling and shaping plate 1505 may be omitted.

### Embodiment 3

Another structure of the calender is further provided below. The calender has a function of film attaching and calendering a material to be processed. The structure and implementation of the calender are still described by using the blank of the WPC foamed floor as the material to be processed.

Based on Embodiment 1 or 2, the calender 1 further comprises a film winding and unwinding mechanism. The film winding and unwinding mechanism comprises one or more of a substrate film winding and unwinding mechanism 161, a wear-resistant film winding and unwinding mechanism 171 and a color film winding and unwinding mechanism 181. Each of the film winding and unwinding mechanisms described above comprises two winding and unwinding wheels, one of which plays a main role while the other of which is standby during an unwinding process of the film.

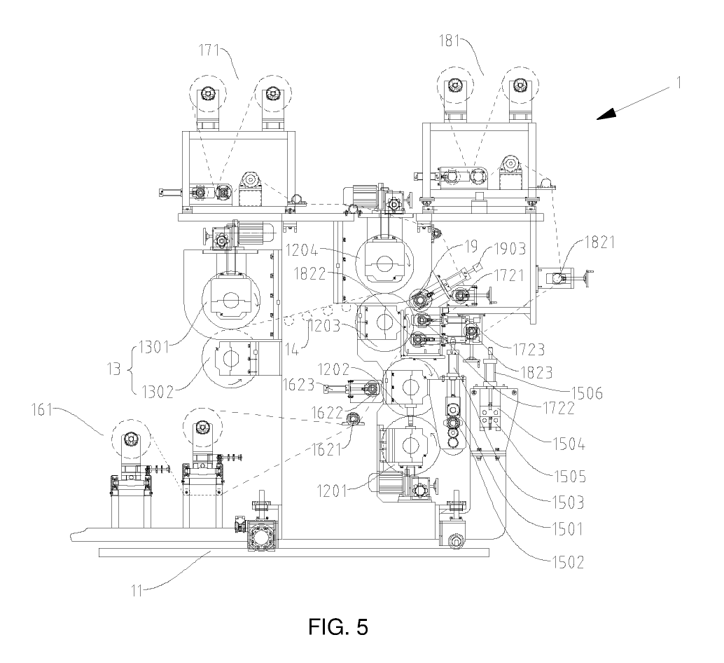

As shown in FIG. 5, the film winding and unwinding mechanism in this embodiment comprises the substrate film winding and unwinding mechanism 161 for unwinding a substrate film, the wear-resistant film winding and unwinding mechanism 171 for unwinding a wear-resistant film and the color film winding and unwinding mechanism 181 for unwinding a color film. The calender 1 further comprises a substrate film guide and attaching mechanism 162 for guiding and conveying the substrate film to one of inter-roller feed ends of the set of primary calendering rollers 12, a wear-resistant film guide and attaching mechanism 172 for guiding and conveying the wear-resistant film to one of the inter-roller feed ends of the set of primary calendering rollers 12 and a color film guide and attaching mechanism 182 for guiding and conveying the color film to one of the inter-roller feed ends of the set of primary calendering rollers 12.

Specifically, referring to the structure of the set of primary calendering rollers 12 in the calender 1 described above, both the wear-resistant film and the color film are guided to a front of the inter-roller feed end between the second intermediate mirror-surface roller 1203 and the delustering roller 1204; and the substrate film is guided to a front of the inter-roller feed end between the first intermediate mirror-surface roller 1202 and the second intermediate mirror-surface roller 1203, so that the substrate film and the other two kinds of films are attached onto different sides of the blank.

It is to be noted that, in practical applications, it is not limited to guiding the substrate film, the color film and the wear-resistant film to the above positions as long as the films can be attached onto designated attaching surfaces. For example, the color film and the wear-resistant film may be guided to the initial feed end of the set of primary calendering rollers 12, and the substrate film may be guided to the final discharge end of the set of primary calendering rollers 12.

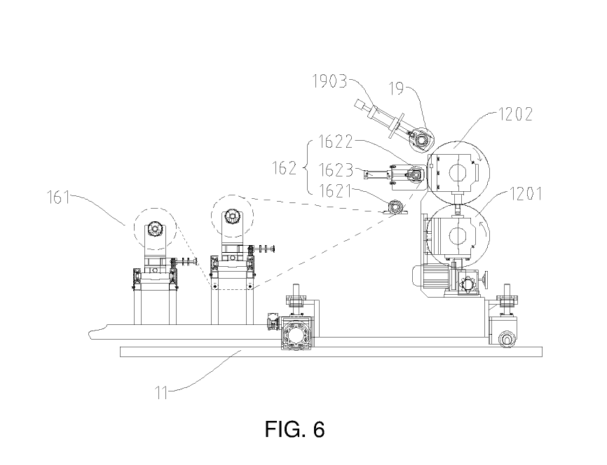

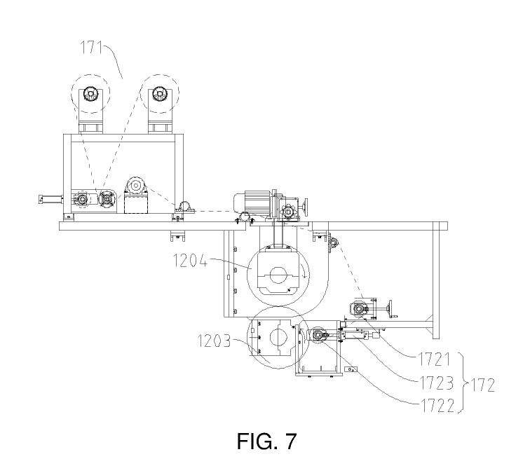

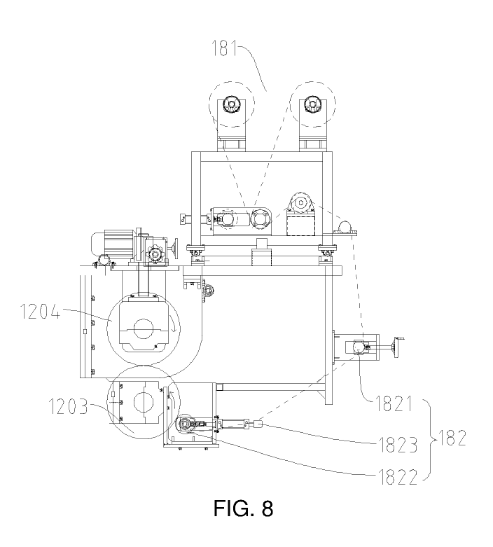

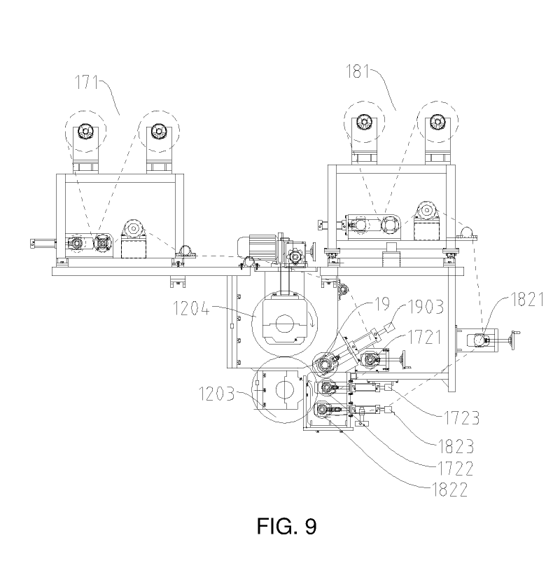

In order to exhibit constitutions and cooperative relationships of components more clearly, a schematic diagram of each component will be further shown. FIG. 6 is a schematic diagram of structures of the substrate film winding and unwinding mechanism 161 and the substrate film guide and attaching mechanism 162 and their cooperations with the calendering rollers; FIG. 7 is a schematic diagram of structures of the wear-resistant film winding and unwinding mechanism 171 and the wear-resistant film guide and attaching mechanism 172 and their cooperations with the calendering rollers; and, FIG. 8 is a schematic diagram of structures of the color film winding and unwinding mechanism 181 and the color film guide and attaching mechanism 182 and their cooperations with the calendering rollers. The substrate film guide and attaching mechanism 162 comprises a substrate film guide wheel 1621 and a substrate film attaching roller 1622 spaced apart from the first intermediate mirror-surface roller 1202. The substrate film attaching roller 1622 is connected to a first gap adjustment cylinder 1623 for adjusting a gap between the substrate film attaching roller 1622 and the first intermediate mirror-surface roller 1202. The wear-resistant film guide and attaching mechanism 172 comprises a wear-resistant film guide wheel 1721 and a wear-resistant film attaching roller 1722. The color film guide and attaching mechanism 182 comprises a color film guide wheel 1821 and a color film attaching roller 1822. The wear-resistant film attaching roller 1722 and the color film attaching roller 1822 are connected to gap adjustment devices for adjusting a gap between the wear-resistant film attaching roller 1722 or the color film attaching roller 1822 and the intermediate mirror-surface roller (specifically, the second intermediate mirror-surface roller 1203). The wear-resistant film attaching roller 1722 is connected to a second gap adjustment cylinder 1723, and the color film attaching roller 1822 is connected to a third gap adjustment cylinder 1823. Due to expansion and contraction actions of the cylinders, the gap between the wear-resistant film attaching roller 1722 or the color film attaching roller 1822 and the intermediate mirror-surface roller is adjusted. It should be understood that, the gap adjustment device can realize gap adjustment and is not limited to a specific structure, and the cylinder is one embodiment. During the production, the color film is attached first, and the wear-resistant film is then attached onto the surface of the color film. Therefore, in a direction of conveying the material to be processed, the wear-resistant film attaching roller 1722 is located in rear of the color film attaching roller 1822, referring to FIG. 9. Following the processing flow, the calender 1 further comprises an auxiliary attaching roller 19 which is located at a rear end of the attaching roller, arranged at a same calendering roller as the attaching roller, and spaced apart from this calendering roller.

Further referring to FIG. 9, in this embodiment, the auxiliary attaching roller 19 is arranged at the inter-roller feed end between the second intermediate mirror-surface roller 1203 and the delustering roller 1204, and the auxiliary attaching roller 19 is located in rear of the wear-resistant film attaching roller 1722 to further compress and attach an attached color film and an attached wear-resistant film. The auxiliary attaching roller 19 is connected to a gap adjustment device for adjusting a gap between the auxiliary attaching roller 19 and the calendering roller. In this embodiment, the gap adjustment device is a fourth gap adjustment cylinder 1903.

In addition to the above structure, an auxiliary attaching roller 19 may also be configured for an attaching of the substrate film. As shown in FIG. 6, the auxiliary attaching roller 19 may be arranged in rear of the substrate film attaching roller 1622 and at the feed end between the first intermediate roller 1202 and the second intermediate roller 1203.

A complete processing flow will be described below. After the blank of the WPC foamed floor is cooled and shaped, the blank enters the set of primary calendering rollers 12 through the gap between the first mirror-surface roller 1201 and the first intermediate mirror-surface roller 1202, and then does a “S”-shaped curvilinear motion along with the calendering rollers. Before the blank is discharged from the first mirror-surface roller 1201 and the first intermediate mirror-surface roller 1202 to enter the gap between the first intermediate mirror-surface roller 1202 and the second intermediate mirror-surface roller 1203, the substrate film is attached on the blank (an auxiliary attaching roller 19 may be optionally provided for auxiliary attaching). When travelling to a front of the inter-roller feed end between the second intermediate mirror-surface roller 1203 and the delustering roller 1204, the blank is firstly attached with the color film unwinded by the color film winding and unwinding mechanism 181. During this process, attaching is realized by the color film attaching roller 1822. Subsequently, the blank is attached with the wear-resistant film unwinded by the wear-resistant film winding and unwinding mechanism 171. During this process, attaching is realized by the wear-resistant film attaching roller 1722. Then, the auxiliary attaching roller 19 will press the wear-resistant film, the color film and the blank for further attaching. After attaching, the blank is calendered between the second intermediate mirror-surface roller 1203 and the delustering roller 1204. The blank is discharged from the discharge end between the second intermediate mirror-surface roller 1203 and the delustering roller 1204, then cooled and enters the set of embossing rollers 13 to realize the knurling and embossing processes. Now, a complete process of film attaching, bottom embossing and top knurling may be completed. The calender in this embodiment may realize all material processing operations of cooling and shaping, calendering and shaping, respectively embossing and knurling on two sides.

### Embodiment 4

This embodiment provides a production line for producing the WPC foamed floor by the calender 1 described in Embodiments 1 to 3.

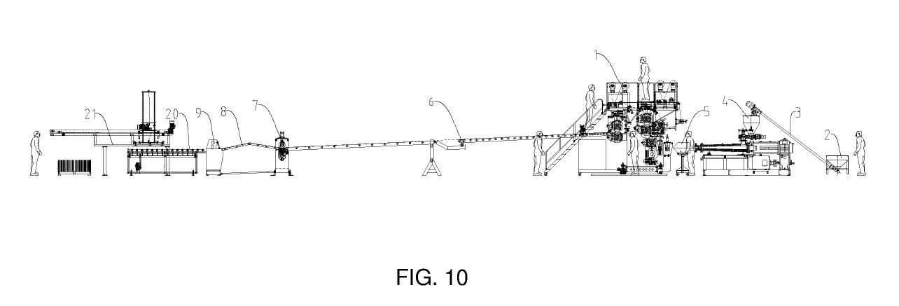

Specifically, referring to FIG. 10, following a production flow of the product, the production line successively comprises mixers 2 (in FIG. 10, the mixer 2 is represented by a storage bin of the mixer for simplification), feeders 3, extruders 4, a mold 5 and a calender 1. The calender 1 is the calender 1 described in any one of Embodiments 1 to 3, and the structure of the calender 1 will not be repeated here.

The mixer 2 is used for mixing powdery materials. Various powdery materials used for producing the WPC foamed floor are fed into the mixer 2 to stir and mix at a high speed. The mixed material, after stirring, is placed into a storage bin of the feeder 3, and then rotatably fed into a hopper of the extruder 4 by the feeder 3.

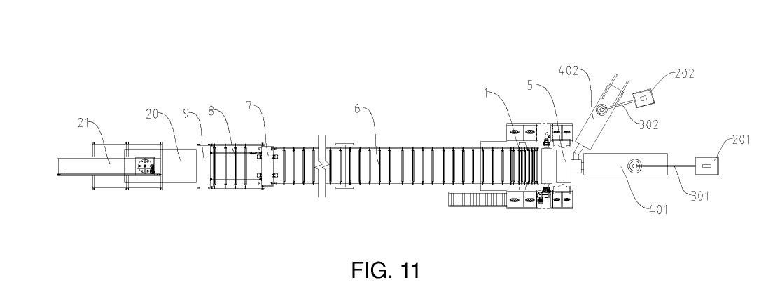

It is to be noted that the WPC foamed floor is formed by combining multiple layers of materials, that is, the foamed floor is mainly composed of a foamed layer and solid layers on two sides of the foamed layer. Prior to entering the mold 5 for extruding, the foamed layer and the two solid layers need to be discharged. Therefore, the extruders 4 comprise two extruders, and each extruder corresponds to its respective mixer and feeder. The two extruders are arranged at an included angle. In this embodiment, the included angle between the two extruders is 60°, referring to FIG. 11. Specifically, the extruders 4 comprise a first extruder 401 (corresponding to a first mixer 201 and a first feeder 301) for extruding the foamed layer and a second extruder 402 (corresponding to a second mixer 202 and a second feeder 302) which is configured with a distributor and used for extruding the solid layers covered on two sides of the foamed layer. Since the second extruder 402 is configured with the distributor, extrudates from the second extruder 402 are two solid layers. The two solid layers are covered and preliminarily attached on two sides of the foamed layer, and then fed into the mold 5.

The mold 5 is used for material processing. Specifically, in this embodiment, the material is a three-layer blank. The three-layer blank is a blank consist of the foamed layer and the solid layers on two sides of the foamed layer. Following the production flow, the calender 1 is located in rear of the mold. Since the mold 5 is at a high temperature, the three-layer blank will be bent in a wavy shape after it is discharged from the mold 5. In order to solve this problem, the cooling and shaping device 15 is provided in front of the calender 1 to cool and shape the three-layer blank.

A cooling and shaping process is as follows: the three-layer blank enters the cooling and shaping device 15 for cooling and shaping after it is discharged from the mold 5. Specifically, after the three-layer blank is discharged from the mold 5, the three-layer blank enters the gap between the first cooling and shaping plate 1504 and the second cooling and shaping plate 1505. Since the cooling and shaping plates are flat and the cooling liquid is fed into the cooling and shaping plates, the cooling and shaping plates exchange heat with the three-layer blank so as to realize cooling and shaping of the three-layer blank. The three-layer blank is basically flat after it is cooled by the cooling and shaping plates; and then, the three-layer blank enters the gap between the first cooling roller 1501 and the second cooling roller 1502 to realize auxiliary cooling and shaping. During the cooling and shaping process, the gap between the first cooling and shaping plate 1504 and the second cooling and shaping plate 1505 and the gap between the first cooling roller 1501 and the second cooling roller 1502 may be adjusted according to requirements on thickness of the three-layer blank. If the two gaps are large, the thickness of the discharged three-layer blank is large; and if the two gaps are small, the thickness of the discharged three-layer blank is small.

After the three-layer blank is discharged from the first cooling roller 1501 and the second cooling roller 1502, the three-layer blank enters the initial feed end of the set of primary calendering rollers 12, and is then subjected to the processing flow of film attaching, bottom embossing and top knurling as described in Embodiment 3 and the subsequent processing steps.

The subsequent processing steps are performed by devices provided after the calender 1. According to the production flow of the product and processing requirements, a cooling bracket 6, a tractor 7, an arched bracket 8, a precise sheet cutting machine 9, a conveying bracket 20, an automatic sheet lifting machine 21 and the like are provided after the calender 1 to realize the cooling and shaping, cutting and other processes of the WPC foamed floor.

### Embodiment 5

One object of the present application is to realize once-forming process for producing the WPC foamed floor. A ratio of PVC powder to calcium powder is about 1:1 in WPC foamed floor, and due to a change of the ratio, controls of foaming processes of the powders and blank are needed to change. Because glue-free films attaching is needed to be completed at the same time, a certain stickiness of the material is required in the calendering process and foaming process. On basis of the above requirement, the process for producing the WPC foamed floor needs to be improved.

This embodiment provides a once-forming process for producing the WPC foamed floor. Compared with conventional processing processes, in the once-forming process, steps such as gluing and pasting are omitted, and thus devices and occupation space are saved. The once-forming process specifically comprises the following steps.

Before the production line is activated, devices respectively working at a certain temperature, such as the mixers 2, the feeders 3, the extruders 4, the mold 5, are preheated and heat preserved. Duration for preheating is determined according to actual requirements. In this embodiment, the duration for preheating is 2 hours. A purpose of the preheating is to make the powdery materials become melts before performing mixing, extruding and other operations. A temperature for preheating is 150° C. to 180° C. In this embodiment, the preheating is performed at 150° C., 160° C. and 180° C., respectively, and working performance is not quite different. If the production line is activated at a temperature below the above temperature range, it is likely to damage screws of the feeders 3, the mixers 2 and reduction gearboxes of the extruders 4, and the service life of the devices is thus influenced.

The powdery materials and auxiliary materials are fed into the mixers 2 and stirred at a high speed, and when a stirring temperature reaches 115° C., added with cold materials and cooled and stirred. After the stirring temperature decreases to about 30° C., the stirred powdery materials are fed into the storage bins of the feeders 3, and then rotatably fed into the hoppers of the extruders 4 by the feeders 3. In this step, the powdery materials comprise powdery materials for producing the foamed layer of the foamed floor and powdery materials for producing the solid layers covered on two sides of the foamed layer; and the extruders 4 comprise a first extruder 401 for extruding the foamed layer and a second extruder 402 for extruding the solid layers. Correspondingly, there are two sets of the mixer 2 and the feeder 3. One set of the mixer 2 and the feeder 3, i.e. the first mixer 201 and the first feeder 301, is used for mixing and feeding the powdery materials for producing the foamed layer, while the other set of the mixer 2 and the feeder 3, i.e. the second mixer 202 and the second feeder 302 is used for mixing and feeding the powdery materials for producing the solid layers.

The material is pushed forward by a rotation of the screw of the extruder 4. It is to be noted that the two extruders 4 work simultaneously: the first extruder 401 extrudes the foamed layer while the second extruder 402 extrudes two solid layers covered on two surfaces of the foamed layer.

Extrudates are squeezed in a cavity of the mold 5 to form the blank of the WPC foamed floor.

Since the mold 5 is at a high temperature, the blank discharged from the mold 5 is in a wavy shape. The blank is cooled and shaped by the cooling and shaping device 15 and then fed to the initial fed end of the set of primary calendering rollers 12. The tests have indicated that, although the blank will be calendered and shaped by the calendering rollers when passing through the set of primary calendering rollers 12, if the step of cooling and shaping before entering the set of primary calendering rollers 12 is omitted, an effect of shaping the blank will be poor and the embossing effect will also be influenced.

Following the processing flow, the set of primary calendering rollers 12 successively comprises a first mirror-surface roller 1201, an intermediate mirror-surface roller and a discharge end calendering roller, wherein a temperature of the discharge end calendering roller is higher than a temperature of the first mirror-surface roller 1201. According to the processing flow, the first mirror-surface roller 1201 is a calendering roller close to a discharge end of the cooling and shaping device 15; the discharge end calendering roller is a calendering roller close to the set of embossing rollers 13; and, the intermediate mirror-surface roller is a transitional calendering roller through which the blank travels from the first mirror-surface roller 1201 to the discharge end calendering roller. The intermediate mirror-surface roller assists in realizing the film attaching process. A number of intermediate mirror-surface rollers is determined according to actual requirements and is not a fixed value. For example, there may be one, two or three intermediate mirror-surface rollers. After cooling and shaping, the blank is then gradually heated, so that properties of the blank are modified gradually. It should be ensured that the blank has been softened sufficiently and has good flatness before preceding the embossing process.

As a preferred implementation, the set of primary calendering rollers 12 successively comprises the first mirror-surface roller 1201, a set of intermediate mirror-surface rollers consisting of at least two intermediate mirror-surface rollers, and the discharge end calendering roller. A temperature design of each calendering roller should follow a strict standard in order to ensure qualities of foaming and embossing. Wherein, temperatures of both the first mirror-surface roller 1201 and the intermediate mirror-surface roller adjacent to the first mirror-surface roller 1201 is set at 30° C. to 90° C., the temperature of the discharge end calendering roller is set at 150° C. to 190° C., a temperature of the intermediate mirror-surface roller adjacent to the discharge end calendering roller is set at 90° C. to 170° C., a temperature of the pattern roller 1301 is set at 160° C. to 190° C., and a temperature of the anilox roller 1302 is set at 160° C. to 190° C. The temperature of each calendering roller will be described by using the structure of the calender 1 in Embodiment 1. The temperatures of both the first mirror-surface roller 1201 and the first intermediate mirror-surface roller 1202 is set at 30° C. to 90° C., the temperature of the second intermediate mirror-surface roller 1203 is set at 90° C. to 170° C., the temperature of the delustering roller 1204 is set at 150° C. to 190° C., the temperature of the pattern roller 1301 is set at 160° C. to 190° C., and the temperature of the anilox roller 1302 is set at 160° C. to 190° C.

The temperature of each calendering roller is related to a thickness of the foamed floor, a thickness of the wear-resistant layer and other factors.

Several sets of data in the specific production processes will be described below.

Production process 1: The thickness of the foamed floor was 5 mm, and the thickness of the wear-resistant layer was 0.15 mm A temperature of the mold 5 was 170° C.; the temperature of the first mirror-surface roller 1201 was 30° C.; the temperature of the first intermediate mirror-surface roller 1202 was 30° C.; the temperature of the second intermediate mirror-surface roller 1203 was set at 130° C.; the temperature of the delustering roller 1204 was set at 165° C.; the temperature of the pattern roller 1301 was set at 165° C.; and the temperature of the anilox roller 1302 was set at 165° C. The blank was discharged from the second intermediate mirror-surface roller 1203 and the delustering roller 1204, then cooled to 110° C., and fed into the set of embossing rollers 13. A 1st WPC foamed floor was obtained by the production process 1.

Production process 2: The thickness of the foamed floor was 7 mm, and the thickness of the wear-resistant layer was 0.3 mm. The temperature of the mold 5 was 175° C.; the temperature of the first mirror-surface roller 1201 was 60° C.; the temperature of the first intermediate mirror-surface roller 1202 was 50° C.; the temperature of the second intermediate mirror-surface roller 1203 was set at 90° C.; the temperature of the delustering roller 1204 was set at 150° C.; the temperature of the pattern roller 1301 was set at 160° C.; and the temperature of the anilox roller 1302 was set at 160° C. The blank was discharged from the second intermediate mirror-surface roller 1203 and the delustering roller 1204, then cooled to 120° C., and fed into the set of embossing rollers 13. A 2nd WPC foamed floor was obtained by the production process 2.

Production process 3: The thickness of the foamed floor was 8 mm, and the thickness of the wear-resistant layer was 0.2 mm. The temperature of the mold 5 was 180° C.; the temperature of the first mirror-surface roller 1201 was 70° C.; the temperature of the first intermediate mirror-surface roller 1202 was 80° C.; the temperature of the second intermediate mirror-surface roller 1203 was set at 160° C.; the temperature of the delustering roller 1204 was set at 185° C.; the temperature of the pattern roller 1301 was set at 170° C.; and the temperature of the anilox roller 1302 was set at 170° C. The blank was discharged from the second intermediate mirror-surface roller 1203 and the delustering roller 1204, then cooled to 125° C., and fed into the set of embossing rollers 13. A 3rd WPC foamed floor was obtained by the production process 3.

Production process 4: The thickness of the foamed floor was 11 mm, and the thickness of the wear-resistant layer was 0.5 mm. The temperature of the mold 5 was 175° C.; the temperature of the first mirror-surface roller 1201 was 90° C.; the temperature of the first intermediate mirror-surface roller 1202 was 90° C.; the temperature of the second intermediate mirror-surface roller 1203 was set at 170° C.; the temperature of the delustering roller 1204 was set at 190° C.; the temperature of the pattern roller 1301 was set at 190° C.; and the temperature of the anilox roller 1302 was set at 190° C. The blank was discharged from the second intermediate mirror-surface roller 1203 and the delustering roller 1204, then cooled to 130° C., and fed into the set of embossing rollers 13. A 4th WPC foamed floor was obtained by the production process 4.

Performance tests were performed on the WPC foamed floors produced by the production processes 1-4 (i.e. the 1st-4th WPC foamed floors) and a WPC foamed floor produced by the conventional process (i.e. a 5th WPC foamed floor), and test results are as shown in Table 1.

TABLE 1
Test results

| | Performance index | | | | |
|---|---|---|---|---|---|
| | 1st WPC | 2nd WPC | 3rd WPC | 4th WPC | 5th WPC |
| | foamed floor | foamed floor | foamed floor | foamed floor | foamed floor |
| Dimensional stability | ≤0.2% | ≤0.2% | ≤0.3% | ≤0.3% | ≤1.2% |
| at 80° C., shrinkage | | | | | |
| Warping performance | ≤0.20 mm | ≤0.25 mm | ≤0.33 mm | ≤0.34 mm | ≤2 mm |
| after heating for 6 | | | | | |
| hours at 80° C. | | | | | |
| Bonding strength | ≥25 kgf/50 mm | ≥25 kgf/50 mm | ≥25 kgf/50 mm | ≥25 kgf/50 mm | ≥17 kgf/50 mm |
| Peeling strength | ≥10 kgf/50 mm | ≥10 kgf/50 mm | ≥10 kgf/50 mm | ≥10 kgf/50 mm | ≥8 kgf/50 mm |
| Residual depression | ≤0.20 mm | ≤0.20 mm | ≤0.20 mm | ≤0.20 mm | ≤0.50 mm |
| Embossing effect | Textures | Textures | Textures | Textures | Textures |
| | were clear | were clear | were clear | were clear | were unclear |
| Glue smell | None | None | None | None | Pungent glue |
| | | | | | smell |

Test results had indicated that, compared with the WPC foamed floor produced by the conventional process, a section of the WPC foamed floor produced by the calender and the process in the present application was foamed uniformly without bubbles and during the extruding process, a current of the extruder was stable and the materials were extruded uniformly, thus the WPC foamed floors produced by the calender and the process in the present application had good foaming effect and in addition, the blanks of the WPC foamed floors were cooled and hot calendared, so that the finished floors had higher strength and good embossing effect, and due to the clear textures, an anti-slip effect could be improved. Due to glue-free in the whole production, the WPC foamed floors produced by the present application were environmental friendly and no harm to people's health.

It is to be noted that the temperatures of both the pattern roller 1301 and the anilox roller 1302 is mainly related to the thickness of the wear-resistant layer. Since the second intermediate mirror-surface roller 1203 and the delustering roller 1204 contacting with the wear-resistant layer mainly function to plasticize the wear-resistant layer and patterns are embossed based on the plasticization, the embossing and knurling effects will be poor if the temperatures of the pattern roller 1301 and the anilox roller 1302 are too low.

The blank is embossed and then discharged from the set of embossing rollers 13, and then transited to the tractor 7 (the tractor 7 mainly functions to push the material to travel forward uniformly) through the cooling bracket 6. Subsequently, the blank is passed through the tractor 7 to enter the arched bracket 8 (having a length of about 2000 mm), is then longitudinally cut to a desired size by the precise sheet cutting machine 9. After being cut, the blank is fed to the conveying bracket 20. During the cutting, leftover material is also cut off. Devices for receiving the leftover material are provided on two sides of the conveying bracket 20. The blank is conveyed to a position where the blank will be gripped by a manipulator. The blank will be conveyed to a tray by the manipulator. When the blanks are stacked to a certain height, the manipulator will give an alarm, and the tray will be replaced by an empty tray after the tray is lifted by a forklift.

After the once-forming process, regimen, cutting, slotting, detecting and packaging, palletizing, putting into storage and packing will be performed. Thus, the production of the WPC foamed floor is completed, and the foamed floor may be sold.

The calender and the process for producing the WPC foamed floor provided by the present application are different from traditional calenders and processes for producing WPC foamed floor and PVC stone-plastic foamed floor. In the present application, the blank is cooled before entering the calendering rollers, and then the blank is also cooled before entering the set of embossing rollers from the set of primary calendaring rollers, and combining with the temperature control of the rollers, the foaming effect and embossing effect can be improved, so as to realize the once-forming process for producing the WPC foamed floor.

What is claimed is:

1. A calender, comprising a base and a set of calendering rollers arranged on the base, wherein, the set of calendering rollers comprises a set of primary calendering rollers and a set of embossing rollers used for embossing a material to be processed; the set of primary calendering rollers and the set of embossing rollers are spaced apart for a distance to allow the material to be cooled before entering the set of embossing rollers from the set of primary calendering rollers.

2. The calender according to claim 1, wherein, a set of cooling rollers is provided between the set of primary calendering rollers and the set of embossing rollers.

3. The calender according to claim 1, wherein, according to a processing flow, the calender successively comprises a cooling and shaping device, the set of primary calendering rollers and the set of embossing rollers.

4. The calender according to claim 3, wherein, the cooling and shaping device comprises a first cooling component and a second cooling component spaced apart; a gap between the first cooling component and the second cooling component allows the material to be processed to pass therethrough and ensures that the material to be processed comes into contact with both the first cooling component and the second cooling component when passing through the gap.

5. The calender according to claim 3, wherein, the cooling and shaping device comprises a first cooling roller and a second cooling roller pairwise spaced apart, and/or, a first cooling and shaping plate and a second cooling and shaping plate pairwise spaced apart.

6. The calender according to claim 5, wherein, at least one of the first cooling roller and the second cooling roller is configured with a cooling pipeline for feeding a cooling liquid; at least one of the first cooling and shaping plate and the second cooling and shaping plate is configured with a cooling pipeline for feeding a cooling liquid.

7. The calender according to claim 5, wherein, at least one of the first cooling roller and the second cooling roller is connected to a cooling gap adjustment device; at least one of the first cooling and shaping plate and the second cooling and shaping plate is connected to a cooling gap adjustment device.

8. The calender according to claim 5, wherein, according to the processing flow, the cooling and shaping device successively comprises a pair of cooling and shaping plates and a pair of cooling rollers; and the pair of cooling and shaping plates comprises the first cooling and shaping plate and the second cooling and shaping plate pairwise spaced apart, and the pair of cooling rollers comprises the first cooling roller and the second cooling roller pairwise spaced apart.

9. The calender according to claim 1, wherein, the set of embossing rollers comprises a pattern roller and/or an anilox roller; and the pattern roller and the anilox roller are configured to come into contact with different surfaces to be embossed of the material.

10. The calender according to claim 1, wherein, further comprises a film winding and unwinding mechanism and a guide and attaching mechanism used for guiding a film unwinded by the film winding and unwinding mechanism to the set of primary calendering rollers; and, the guide and attaching mechanism comprises a guide wheel and an attaching roller spaced apart from the calendering rollers in the set of primary calendering rollers.

11. The calender according to claim 10, wherein, the film winding and unwinding mechanism comprises any one of or any combination of a substrate film winding and unwinding mechanism for unwinding a substrate film, a color film winding and unwinding mechanism for unwinding a color film, and a wear-resistant film winding and unwinding mechanism for unwinding a wear-resistant film; and, if the substrate film winding and unwinding mechanism is configured to guide the substrate film to one side of the material, both the color film winding and unwinding mechanism and the wear-resistant film winding and unwinding mechanism are configured to guide the color film and the wear-resistant film to an other side of the material.

12. The calender according to claim 10, wherein, further comprises an auxiliary attaching roller, according to the processing flow, the auxiliary attaching roller is located at a rear end of the attaching roller, arranged at a same calendering roller as the attaching roller, and spaced apart from the calendering roller.

13. The calender according to claim 12, wherein, each of the attaching roller and the auxiliary attaching roller is connected to a gap adjustment device for adjusting a gap between the attaching roller or the auxiliary attaching roller and the calendering roller in the set of primary calendering rollers, respectively.

14. A production line for a foamed floor, wherein, comprising the calender as claimed in claim 1.

15. A once-forming process for producing a foamed floor, wherein, realized based on the production line for the foamed floor of claim 14, comprising following steps: discharging a material by the set of primary calendering rollers, and then cooling the material during conveying, and whereafter, feeding the material into the set of embossing rollers for embossing.

16. The once-forming process for producing a foamed floor according to claim 15, wherein, further comprises following steps: cooling and shaping the material by a cooling and shaping device firstly, and then feeding the material to the set of primary calendering rollers.

17. The once-forming process for producing a foamed floor according to claim 15, wherein, according to a processing flow, the set of primary calendering rollers successively comprises a first mirror-surface roller, an intermediate mirror-surface roller and a discharge end calendering roller and a temperature of the discharge end calendering roller is higher than a temperature of the first mirror-surface roller.

18. The once-forming process for producing a foamed floor according to claim 17, wherein, according to the processing flow, the set of primary calendering rollers successively comprises the first mirror-surface roller, a set of intermediate mirror-surface rollers consisting of at least two intermediate mirror-surface rollers, and the discharge end calendering roller, and temperatures of both the first mirror-surface roller and an intermediate mirror-surface roller adjacent to the first mirror-surface roller are set at 30° C. to 90° C., the temperature of the discharge end calendering roller is set at 150° C. to 190° C., a temperature of an intermediate mirror-surface roller adjacent to the discharge end calendering roller is set at 90° C. to 170° C.

19. The once-forming process for producing a foamed floor according to claim 17, wherein, the set of embossing rollers comprises a pattern roller or an anilox roller, or a combination of a pattern roller and an anilox roller; a temperature of a pattern roller is set at 160° C. to 190° C., and a temperature of an anilox roller is set at 160° C. to 190° C.

20. The once-forming process for producing a foamed floor according to claim 18, wherein, the set of embossing rollers comprises a pattern roller or an anilox roller, or a combination of a pattern roller and an anilox roller; a temperature of a pattern roller is set at 160° C. to 190° C., and a temperature of an anilox roller is set at 160° C. to 190° C.
